(19) United States
(12) Patent Application Publication
(10) Pub. No.: US 2006/0227121 A1
(43) Pub. Date: Oct. 12, 2006

(54) Systems and methods for providing a dual mode input device in a computing system

(75) Inventor: Thomas C. Oliver, Windsor, CO (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 11/095,297

(22) Filed: Mar. 30, 2005

(51) Int. Cl. G09G 5/00

(52) U.S. Cl. 345/179

(57) ABSTRACT

Systems and methods for providing a dual mode input device, such as a pen or a stylus, in a computing system are provided. Storage is provided inside the input device for a variety of types of data files other than for storing positional information and a corresponding storage access mode is provided to read, write or render from the storage, so that the input device may store, transmit, receive and otherwise operate upon data, such as music, files, pictures, etc., while also having an input mode that relates to the ordinary operation of the pen or stylus, either active or passive.

### FIELD OF THE INVENTION

The present invention provides systems and methods for providing a dual mode input device, such as a pen or a stylus, in a computing system, having storage on the input device for storing data. More particularly, the invention provides a dual mode input device having storage for data other than the usual tracking information stored temporarily when tracking the movement of the input device.

### BACKGROUND OF THE INVENTION

User interaction with computers continues to increase each day. More jobs require individuals to interact with computers and more people are choosing to interact with computers for both work and entertainment. Various tracking devices for interacting with a computer include electronic mice, keyboards, joysticks, and touch pads. Other tracking devices, including personal digital assistants (PDAs), cellular telephones, and electronic pens or styluses, allow users to interact with different computers and computer systems.

Tracking devices generally fall into one of two types of systems: relative tracking systems or absolute tracking systems. A relative tracking system has the ability to discern relative motion from one position to another, independent of knowledge of absolute position. Methods of relative optical tracking include image correlation, differential pattern gradient based, laser speckle based and Doppler-based among others. One feature of a relative tracking system is that one or more sensors detect signals that change over time and can be processed in various ways to determine changes in relative position. An absolute tracking system has the ability to discern a position of the device irrespective of a previous determination. Pens, for instance, commonly implement absolute tracking systems, and input devices generally implement one or the other, but not both relative and absolute tracking systems. Cost, size, and difficulty in combing the two from a technological standpoint have left manufactures choosing from one of the two methods when constructing their respective devices, though some pens may include both types of systems. For instance, commonly assigned copending U.S. patent application Ser. No. 10/891,484, entitled “Methods and Apparatuses for Compound Tracking Systems,” filed Jul. 15, 2004 describes such a system.

As the use of pens becomes more ubiquitous with PCs, laptops, handheld devices such as PDAs, and other mobile devices, the number of computing device scenarios that require a user to bring a pen along with the computing device has also increased. Currently, for instance, a traveler may need to carry both a pen and a storage device on a business trip. Precious space is required to carry each device so the user may decide not to carry one or both. Consequently, in order to make a pen more appealing to a customer, it would be desirable to increase the functionality of the pen beyond its computing device input tracking functionality. It would be further desirable if the pen could be used as both a pen and as a storage device. It would be still further desirable to allow a user to simply switch between two modes corresponding to the enhanced functionality of the pen device and the ordinary operation of the pen device, such as allowing a user to switch simply between ordinary pen mode and storage device mode. If such a device were provided, the customer would only need to carry a single device.

### SUMMARY OF THE INVENTION

In view of the foregoing deficiencies identified in the state of the art, the present invention provides systems and methods for providing a dual mode input device, such as a pen or a stylus, in a computing system. More particularly, the invention relates to the provision of storage inside the input device and a corresponding storage access mode to read, write or render from the storage, so that the input device may store data, such as music, files, pictures, etc., while also having an input mode that relates to the ordinary operation of the pen or stylus.

Other features of the present invention are described below.

### BRIEF DESCRIPTION OF THE DRAWINGS

The system and methods for providing a dual mode input device are further described with reference to the accompanying drawings in which:

FIG. 1 is a block diagram of an exemplary non-limiting input device representative of the type of input device in which the present invention may be implemented;

FIG. 2 is a block diagram representing an exemplary non-limiting electronic pen and associated functionality generally illustrating the ordinary operation of the electronic pen as an input device;

FIG. 3 is an exemplary non-limiting flow diagram representing a typical use scenario for the ordinary operation of an electronic pen as an input device in accordance with one mode of the present invention;

FIGS. 4A to 4C illustrate exemplary non-limiting embodiments of a dual mode storage pen in accordance with the invention;

FIGS. 5A to 5D illustrate exemplary non-limiting embodiments of various use scenarios for a dual mode electronic storage pen in accordance with the invention;

FIG. 6 is an exemplary non-limiting user interface display enabling the access of and transfer of files on a dual mode electronic storage pen in accordance with various embodiments of the invention;

FIG. 7A is a block diagram representing a suitable computing system environment in which the present invention may be implemented;

FIG. 7B is a block diagram representing an exemplary network environment in which the present invention may be implemented; and

FIGS. 8A to 13B illustrate exemplary ways in which similar interface code can be provided to achieve similar or equivalent objective(s) of any interface(s) in accordance with the invention.

### DETAILED DESCRIPTION OF ILLUSTRATIVE EMBODIMENTS

Overview

As mentioned in the background, currently, a traveler may need to carry both a pen and a storage device on a business trip. Precious space is required to carry each device, so the user may decide not to carry one or both. Accordingly, to address this and other scenarios, the invention provides a pen that can be used as both a pen and as storage device. In one embodiment, the pen or stylus of the invention contains a switch to select between one of two modes: pen mode or storage device mode. For the avoidance of doubt, a stylus as the term is utilized herein refers to both active and passive kinds of styluses, i.e., with or without internal electronics apart from the storage capabilities of the present invention. Moreover, the term is meant to signify both tethered (e.g., by a string or cord) and un-tethered styluses alike. In other embodiments, the storage device stores music, such as MP3 files, and is capable of playing music files and outputting the sound via headphones, speakers, or the like. Thus, the customer using the dual mode pen of the invention can carry fewer devices while enjoying the same functionality that multiple devices provide.

In one embodiment, flash storage is added to the input device, such as an electronic pen, and a file system allows the reading and writing of the flash storage to render music such as music files, or to store data such as data files. Interfaces are provided in the pen that enable a user to easily exchange data with another computing device, e.g., via any wired or physically connected means, such as a USB port, any wireless means, such as communications according to the 802.11x or Bluetooth protocols, or any other exchange mechanism commonly used for exchanging data between two computing devices as would be appreciated by one of ordinary skill in the art.

Systems and Methods for Providing a Dual Mode Electronic Input Device

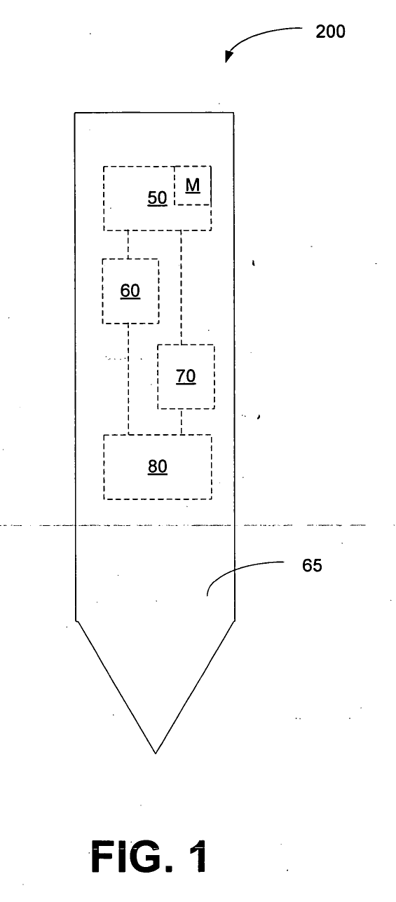

FIG. 1 is a side view of an exemplary computer input device 200 with a schematic representation of internal components in which the invention may be implemented. Computer input device 200 includes a longitudinally extending housing 65, e.g., a cylindrical shape or sometimes having a hexagonal or rectangular (or other shaped) cross-section, which typically comes to some point, or other narrower portion than the rest of longitudinally extending housing 65, which generally operates as a point of input for the input device 200. Computer input device 200 may be an electronic pen-type device. Computer input device 200 may include actuatable buttons and/or sensors, such as zero travel binary contact sensors or Force Sensitive Resistors (FSRs), allowing a user to press and click an entry and/or perform an action with the computer input device 200. Computer input device 200 also is shown to include a control system 50, a relative tracking subsystem 60 and/or an absolute tracking subsystem 70, and sensor(s) 80. Reference elements 50, 60, 70 and 80 are shown in broken line form to represent that these components may be internal to the computer input device 200. In all applicable embodiments of the invention, computer input device 200 may optionally include a power source, such as a battery (not shown).

Control system 50 may be a custom silicon chip, a digital component, and/or a microprocessor component for computation of data, processing of signals, and interface with a host computer (not shown). Control system 50 is shown to be connected to each subsystem, relative tracking subsystem 60 and/or absolute tracking subsystem 70. Each tracking subsystem 60 and/or 70 is shown connected to sensor(s) 80. As shown in FIG. 1, each subsystem uses the sensor(s) 80 for capturing data for tracking the movement of the computer input device 200. Although not shown in FIG. 1, each tracking subsystem 60 and 70 may have an independent sensor 80 for tracking purposes. Further, it should be understood that sensor(s) 80 may be included within each subsystem 60 and 70. It should be understood that if a common sensor 80 is used for both subsystems 60 and 70, the frame rates for each subsystems may be different and the quantity of data provided to each subsystem may be different. For example, a larger set of data may be captured and needed for the absolute position decoding, while a subset of that data can be used for the relative tracking, allowing quicker processing.

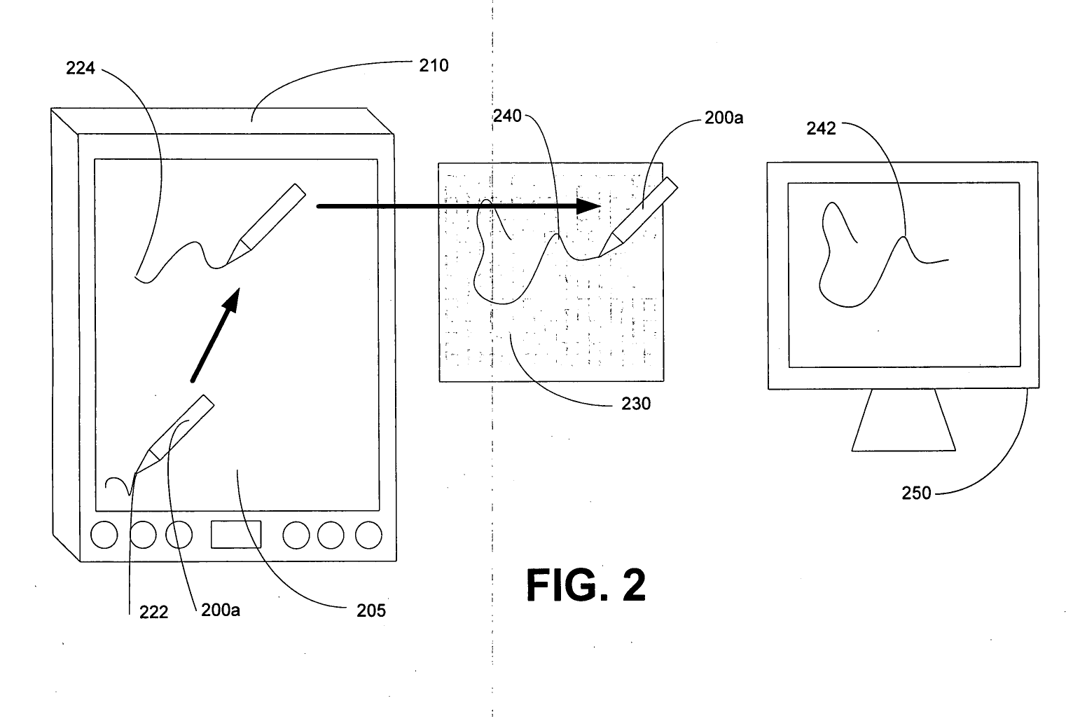

Sensor(s) 80 capture data corresponding to movement of the computer input device 201. The data is sent through the relative tracking subsystem 60 and/or the absolute tracking subsystem 70 where the data is processed to determine position data representative of the approximate position of the computer input device 200. The position data is then transferred via any wired or wireless means to the control system 50 where the data is subsequently sent to a host computer (not shown) for use in an application program. For example, the movement of the computer input device 200 may correspond to the movement of a cursor position on a display of the host computer as shown in FIG. 2 and described below. Although not shown in FIG. 1, control system 50 may include a memory M, such as register storage or flash storage, which is used solely for storing the position data for transmission to the host computer at a later time. In recognition that the specialization of use of memory M in existing devices prevents its use for other purposes, the invention provides a second mode for an input device 200 that makes use of memory M for reasons other than storing the position data for processing input data from the sensor(s) 80 or for later transmission to a host computer.

Computer input device 200 thus represents an illustrative example of a tracking device that is configured to track the movement of the computer input device 260 by a relative tracking method and/or an absolute tracking method. The capability to track based upon a relative tracking method or an absolute tracking method may be contained within the same physical housing 65 of computer input device 200. It should be understood by those skilled in the art that control system 50, relative tracking subsystem 60 and absolute tracking subsystem 70 may be implemented by hardware components, software components, firmware components, and/or any combination of hardware, software, and firmware components.

FIG. 2 is a schematic diagram of an illustrative embodiment of a computer device tracking system for use with a computer application in accordance with at least one aspect of the present invention. FIG. 2 illustrates how a computer input device, such as an electronic pen 200a, can be used to track movement of the electronic pen 200a based upon a relative tracking method and/or an absolute tracking method during ordinary operation. Thus, FIG. 2 illustrates some exemplary scenarios showing use of a computer input device 200 such as electronic pen 200a. For instance, a user can use electronic pen 200a on a screen 205 of a notebook type computer 210, or PDA, or other portable computing device. Screen 205 is a predefined area in which the position of the electronic pen 200a can be tracked. As an example of an exemplary use of pen 200a, as a user moves the electronic pen 200 across the surface of the screen 205, the position of the electronic pen 200a may be tracked based on a relative tracking system. In such a case, points of contact 222 and 224 may be determined relative to other positions, to a trajectory of contact points, and/or some other relative feature.

In accordance with at least one aspect of the present invention, the user can also use an electronic pen 200a on a piece of encoded paper 230, such as a sheet of paper that includes an embedded pattern, such as generally shown on encoded paper 230 in FIG. 2. As the user moves the electronic pen 200a across the surface of the paper 230, the movement 240 of the point of contact of the electronic pen 200a against the surface of the paper 230 can be tracked. The movement 240 can be tracked based upon an absolute tracking method utilizing the encoded surface information. For example, a user can draw an object on the paper 230 and the object is entered into an application program running on a host computer. For instance, a monitor 250 connected to the host computer can display the corresponding object 242. In such a case, the electronic pen 200a communicates with the host computer to send absolute position data for the application running on the host computer to use. It should be understood by those skilled in the art that the application program may be external to the host computer as well. Therefore, under at least one embodiment, the compound tracking device 200a may be used for absolute tracking purposes and/or relative tracking purposes without a host computer.

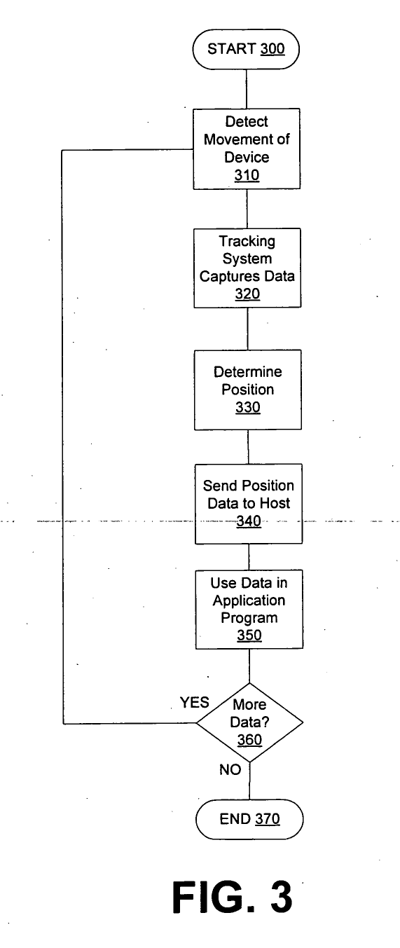

FIG. 3 is a flow chart of another illustrative method for tracking movement of a device in accordance with at least one aspect of the present invention. The process starts at 300 and at step 310, movement of the device is detected. Upon detection of movement, either a relative tracking system and/or an absolute tracking system captures data in step 320. The relative position data and/or absolute position data are then used, at step 330, to determine the position of the device. Such an implementation may be used to generate precise position information. At step 340, the position data is then sent to the host computer. At step 350, the host computer uses the data for an application program running on or external to the host computer. The process moves to step 360 where a determination is made as to whether more data needs to be captured. If more data needs to be captured, the process returns to step 310. If not, the process ends at 370. It should be understood by those skilled in the art that the position data may be stored in memory on the device before sending the position data to the host computer and that the example shown in FIG. 3 is but one example.

In consideration of the limited input functionality of today's stylus type input devices, the invention provides in various embodiments a dual-mode pen storage device and associated interfaces and user interface (UI) for storing/retrieving files via a host device and its application(s). In one embodiment, the invention is directed to a dual use camera stroke capture pen that also includes user accessible on-board memory for file storage, giving the camera pen similar functionality to a key-chain flash drive. The camera pen's existing interface with the host PC can be used to transfer files to/from memory, and a user actuatable switch may be placed on the pen to place the pen into file storage mode.

While currently, some electronic pens have flash memory, it is used only for storing pen strokes. In one embodiment of the invention, the electronic pen accesses part of the flash storage used for pen stroke information, making that part accessible as a pen storage device to which files could be download, e.g., via USB or Bluetooth, and the pen then holds the files for transportation, e.g., while the pen user is mobile.

In one embodiment, the electronics of the input device are modified to provide security for the files, e.g., over-write protection or encryption, in case the pen is lost.

Optionally, the storage pen of the invention may include a UI on the device, though it is unnecessary in an embodiment wherein a host computer includes UI for storing and retrieving files, and otherwise interacting with the storage of the pen input device.

Another scenario contemplated by the invention is that currently, travelers may wish to carry both a pen and a music player on a business trip. The storage pen of the invention may thus also enable the storage of music or other content on the storage pen, so that a user may output audio from the storage device rendering the music. The dual-mode pen-music player could thus be used as both a pen and as a music player. In various embodiments, the pen includes a switch to select one of two modes: pen or music storage and player.

In other embodiments, the invention provides methods for selecting two modes of operation in a pen input device including an ordinary pen operation mode and a music mode. In these embodiments, part of flash storage provided in a pen input device is also used as storage for music, although the invention is not limited to just one kind of storage, such as flash storage, and such storage may be provided independently of the storage for pen movement information. In this regard, any technically feasible storage recognizable by one of ordinary skill in the art as being suitable for an electronic pen device is a suitable type of storage for use with the invention. Thus, in one scenario of the invention enabled by this embodiment, a user would download the music to the pen (via USB or Bluetooth) and then the pen would have the ability to playback the music in music mode.

In various embodiments of the dual mode pen/music player of the invention, the pen electronics process the music data (perform decoding) and produce an analog signal to a speaker or headphone jack. Alternatively, the electronics send a digital signal via a wireless link (Bluetooth) for playback with a wireless headset (which produces an analog signal corresponding to the digital music signal). The electronics of the device include the decoding algorithms to decode many of the popular standard music formats, e.g., MPEG-1 Audio Layer-3 (MP3), Windows Media Audio (WMA), etc. The pen may utilize a UI to select the music mode of operation and to select song tracks. In one embodiment, a simple LCD and associated controls or buttons are provided to select and play music, and perform other tasks like fast forward, or reverse, and next or previous song.

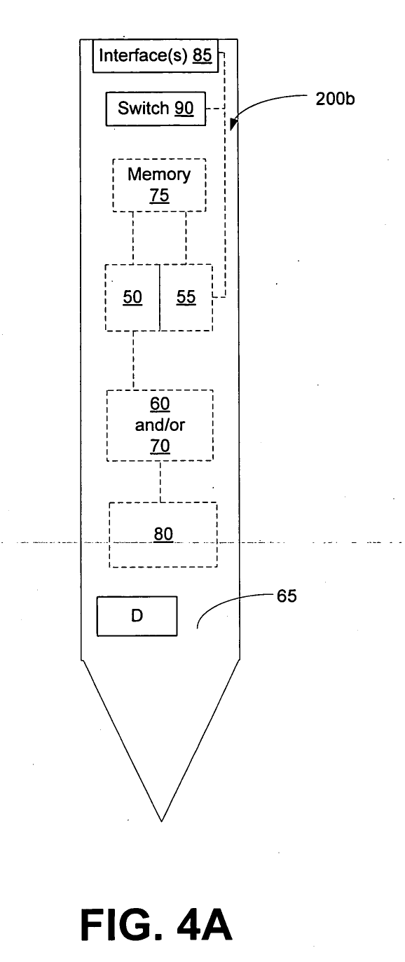

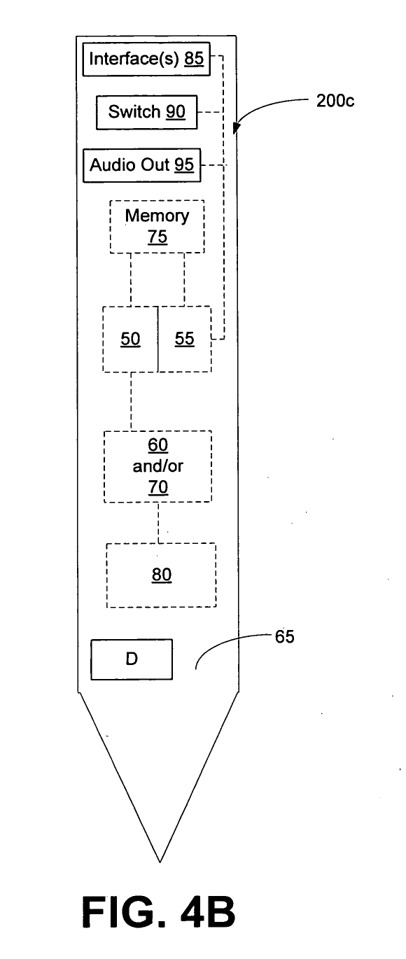

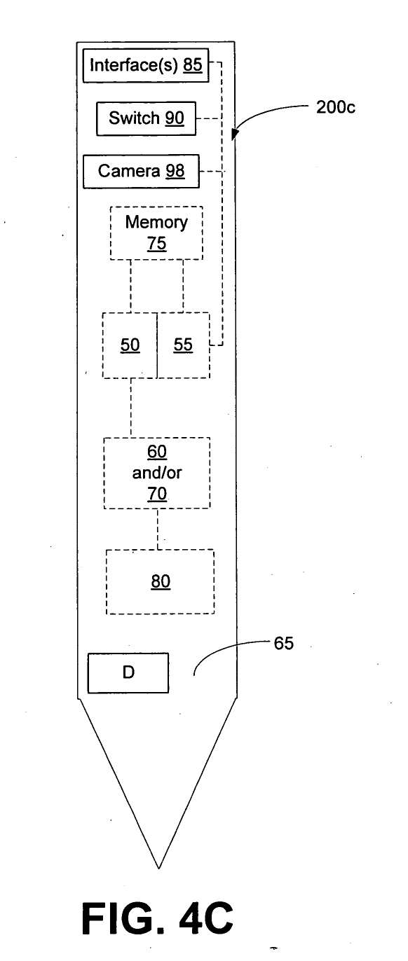

As illustrated in FIG. 4A, a first embodiment of the invention is shown. In FIG. 4A, similar to FIG. 1, electronic pen 200b includes a housing 65 and control unit 50, tracking subsystem(s) 60 and/or 70, sensor(s) 80, i.e., the transmission electronics for outputting positional information about the pen 200b during ordinary or customary use of the pen 200b as an input device. In FIG. 4A, memory 75, such as a flash memory, ordinarily operates to store positional information from the sensor(s) 80 and/or tracking subsystem(s) 60 and/or 70. In accordance with the invention, part of memory 75 is utilized to store data files other than data relating to the positional information. In this regard, a second mode and second control 55 (could be integrated with control 50) is provided to interact with memory 75 (a “separate” memory may also be provided for this purpose)—to store data files, to retrieve data files, to delete data files and/or to otherwise operate on the data files in the pen 200b to perform some function with respect thereto, such as play a music file, view an image or document, via an application that cooperates with or is integrated with control 55.

In one embodiment of the invention, a switch 90 is provided for switching between pen mode under control of control unit 50 for generating and transmitting positional information about the pen 200b during ordinary pen operation, and a storage mode under control of control unit 55 for storing, retrieving, deleting or otherwise operating on data files, such as personal content, stored in memory 75. Switch 90 may be any control known to those of ordinary skill in the art for inputting user selections to choose a mode. For instance, display D may include a UI that enables the user to select a mode, or buttons or a switch or other mechanical mechanism, may be actuated to switch the mode of pen 200b. Additionally, although not shown in the FIG. 4A, via a UI of a host computing device or button of a peripheral of the host computing device (e.g., button of a keyboard, mouse, etc.), a user may select a command that switches the pen 200b between pen mode and storage mode. Such command is then transmitted to the pen 200b, and pen 200b switches modes upon receiving the command.

Pen 200b also includes interface(s) 85, which may be provided as software, e.g., application programming interfaces (APIs), hardware (e.g., USB or Bluetooth transceiver) or a combination thereof, for transmitting and receiving data, such as data files stored in or to be stored in memory 75, to and from the pen 200b and a host device (not shown in FIG. 4A). A display D may also optionally provided to the extent that user interaction with pen 200b would be aided by a user interface for interacting with the data files stored in memory 75.

FIG. 4B illustrates another pen embodiment 200c of the invention wherein control 55 includes software for controlling the retrieval and rendering of music files. In operation, interface(s) 85 may also include a user interface external to or located on the housing 65 that enables the retrieval and playback of music files stored in memory 75, outputting an audio signal to audio out 95 for speakers, headphones, etc. Thus, in effect, pen 200c has a pen mode for ordinary operation of the pen under control of control unit 55 and a music mode for the music playback experience including a UI optionally displayed on display D, if display D is included in pen 200c, for user interaction with the music data in 75 under control of control unit 55.

FIG. 4C illustrates yet another pen embodiment 200d of the invention wherein the pen 200c also includes a camera 98, whereby camera 98 captures video and/or image data for storage in memory 75. Once again, display D may optionally be included for display of image and/or video data, or to otherwise interact with the file system that interacts with data files in memory 75. Interface(s) 85 enable the downloading of data files from a host device (not shown) or uploading of data files from the pen 200d to the host device, and switch 90 switches the pen 200d from the pen mode for ordinary operation of the pen 200d as an input device and a camera mode for operating the pen 200d as a camera, and otherwise utilizing camera applications to interact with the image and/or video files captured by the device in memory 75.

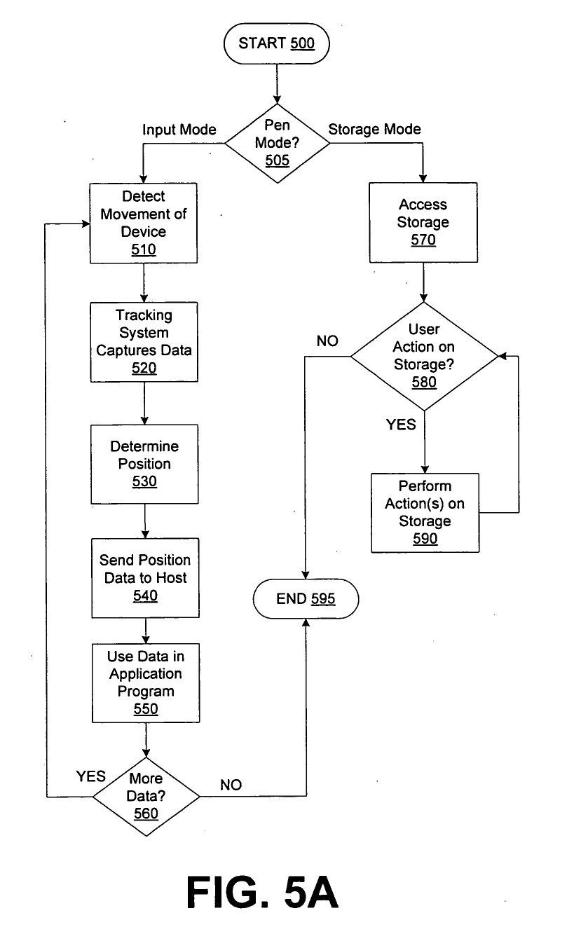

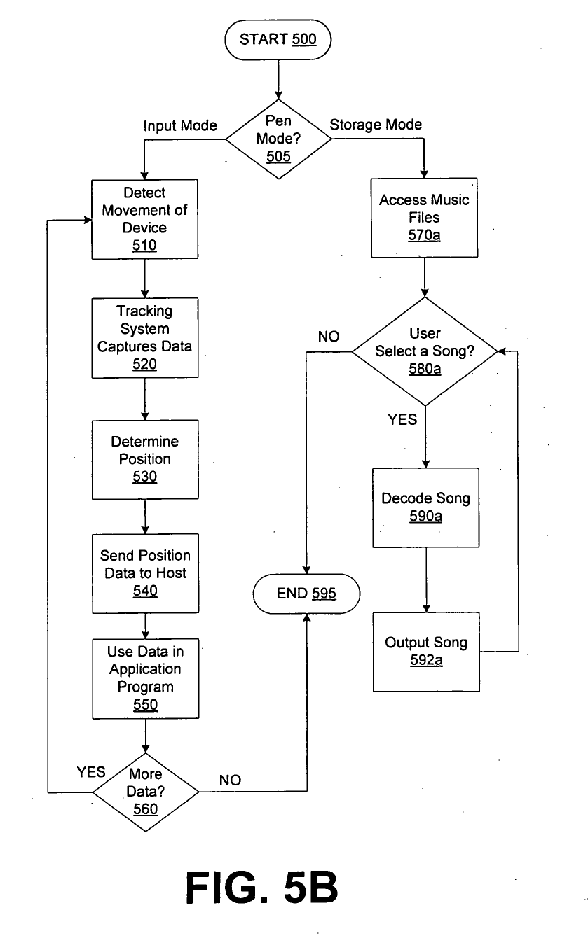

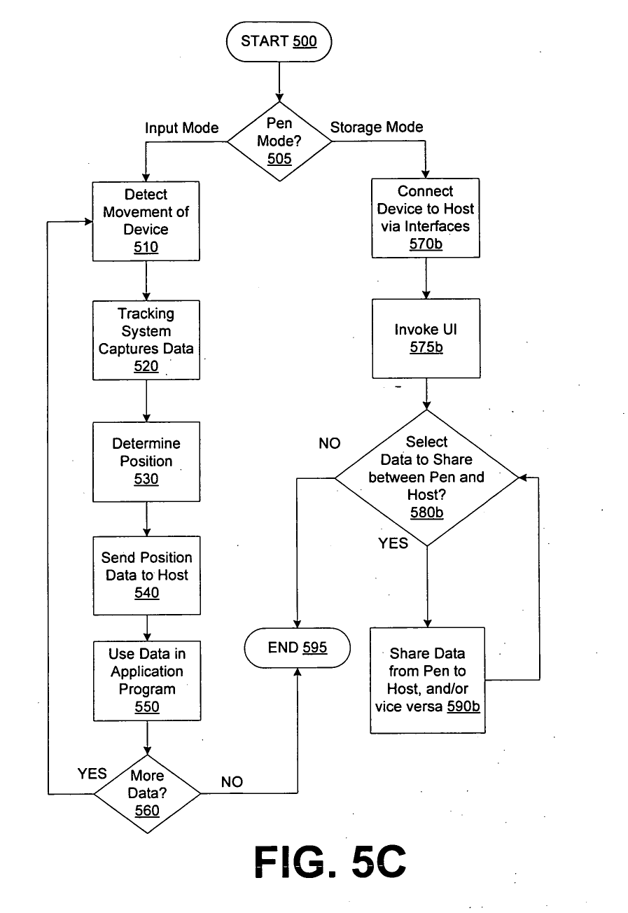

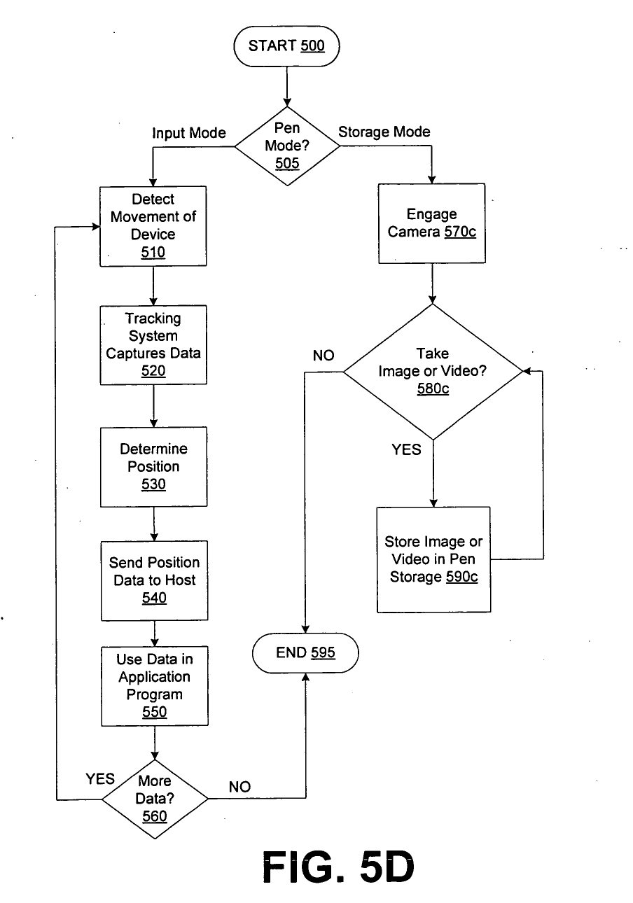

FIG. 5A illustrates an exemplary flow diagram for operation of a pen, such as pen 200b of FIG. 4A, in two modes: an input mode for receiving positional information about the pen and a storage mode for receiving data files, such as personal content from a user. In any one of known ways for capturing positional information about a pen device, after start 500, a determination is made at 505 concerning which mode of operation the pen is in. If the pen is in input mode, then movement of the pen device is detected at 510. At 520, the tracking system captures data relating to the movement of the pen device. At 530, the position of the pen device is determined based on the data captured at 520. At 540, the data is sent to a host device to which the positional information input of the pen device is directed (e.g., for control of the UI of the host device). At 550, the host device uses the positional information in an operating system, application and/or service in accordance with standard graphical user interface (GUI) techniques. If more data is to be captured from the pen device at 560, e.g., in an ongoing GUI experience, then the flow returns to the detection of movement at 510. When there is no more data to be captured by the pen device, the flow ends at 595.

At any time during operation of the pen device in input mode, if the user switches the pen device to storage mode, in an exemplary fashion, now the pen device operates to make data files, such as music files, images, word processing documents, spreadsheet documents, etc. not relating to or used during the input mode and saved in storage of the pen device, such as flash storage, accessible to the user. In storage mode, at 570, a user is able to access the storage of the pen device and perform operations on the data files therein according to the particular type of file stored in the pen device. At 580, for instance, a user may take an action on a data file in the storage, e.g., delete a file, open or play a file, transmit a file to a host via interface(s) 85, receive a file from a host via interface(s) 85, etc. At 590, action is taken on the storage according to the designated actions by the user at 580. When there are no mode actions to be taken on the data files stored in memory of the pen device, flow ends at 595. At any time during operation of storage mode, if the user switches the pen device to input mode, the flow goes to detection of movement of the pen at 510.

FIG. 5B illustrates an alternate flow diagram for the operation of a pen device in accordance with the present invention. Similar to FIG. 5A, FIG. 5B includes an input mode and a storage mode. In this embodiment, in storage mode, the pen device may be utilized similar to an MP3 player or other portable music player, which enables a user to store music on the pen device and playback the music according to known playback techniques. For instance, at 570a, in storage mode, a pen device accesses and a user is able to access the music files stored in memory, such as flash memory, of a pen device. At 580a, a user may select or otherwise interact with a song. If a user selects a song, then the song is decoded at 590 and an audio signal is output at 592a. When there are no more actions taken with respect to songs, the flow ends at 595. At any time during operation of the pen device in storage mode, if the user switches the pen device to input mode, the flow goes to detection of movement of the pen at 510. In this regard, the invention applies to streaming media, i.e., music or other audio signal that is streamed to the storage pen via wired or wireless means and temporarily (or permanently) stored in storage in the pen, as well as standalone files resident in storage of the pen. For the avoidance of doubt, the term “audio signal” as used herein is intended to signify both digital and/or analog representations of sound, such that the pen device of various embodiments of the invention may output to wired headphones, speakers, amplifiers, etc. as well as to Bluetooth enabled headphones, or other wireless devices communicatively coupled to the storage pen device of the present invention.

FIG. 5C illustrates another alternate flow diagram for the operation of a pen device in accordance with the present invention. Similar to FIG. 5A, FIG. 5C includes an input mode and a storage mode. In this embodiment, in storage mode, the pen device may be utilized as a storage device for physically transferring files to and from a pen device and other computing devices. For instance, at 570b, in storage mode, the pen device is connected to a host device via a set of interface(s) that enable the two devices to exchange data according to any known protocol(s) for exchanging data between two devices, e.g., via a USB input, Bluetooth wireless exchange, etc. At 575b, the host device may include a UI associated with the operating system of the host that presents the pen device as a storage drive on the host, and allows the user to interact with the files stored in memory of the pen device via the file system of the host machine. At 580b, a user may select data to share between the pen device storage drive and the host, either transferring files from the host device to the pen device, transferring files from the pen device to the host device, or deleting or modifying the files on the pen device. At 590b, the data is operated upon according to the action selected by the user at 580b. When the pen device is disconnected from the host machine, or when there is no more data to be shared or modified with respect to the data files in the pen device, the flow ends at 595. At any time during operation of the pen device in storage mode, if the user switches the pen device to input mode, the flow goes to detection of movement of the pen at 510.

FIG. 5D illustrates yet another alternate flow diagram for the operation of a pen device in accordance with the present invention. Similar to FIG. 5A, FIG. 5DC includes an input mode and a storage mode. In this embodiment, in storage mode, the pen device may be utilized as a camera device for capturing events in time, such as images or video, and is capable of storing such image or video data in memory, such as flash memory, of the pen device, and transfer those files between the pen device and any host machine, e.g., as described in connection with FIG. 5C. For instance, at 570c, in storage mode, the pen device engages the camera, e.g., the lens is readied for picture taking. The user may perform focusing, shudder control, etc. on the camera during this time to get ready for picture or video taking. At 580c, the time capture of image or video is performed by the camera. At 590c, such images and/or video are stored in the pen device. Such data may be transferred to and from a host computing device, and optionally may be displayed on a small display D, such as an LCD display, of the pen device. When there is no more image or vide data to be captured by the camera of the pen device, the flow ends at 595. At any time during operation of the pen device in storage mode, if the user switches the pen device to input mode, the flow goes to detection of movement of the pen at 510.

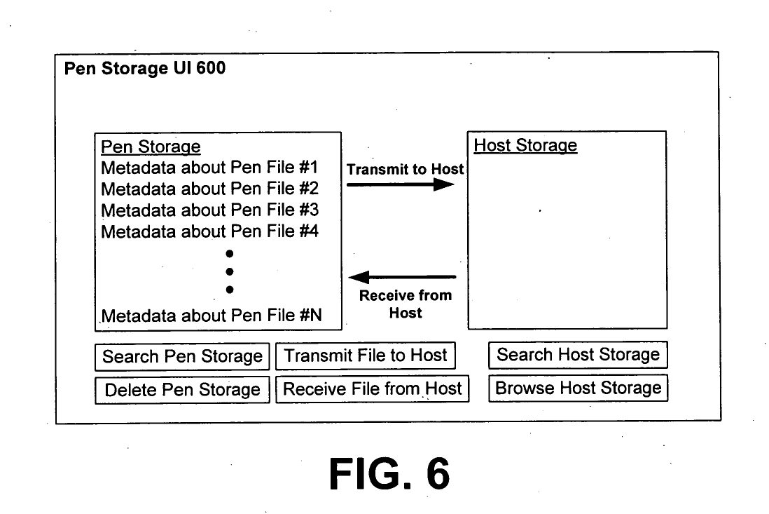

FIG. 6 illustrates an exemplary user interface 600 of a host computer as it relates to pen storage such as might be utilized to exchange data between storage on the host computer and the pen storage. Thus, in this embodiment, metadata about the pen files in pen storage are retrieved and displayed on one side of UI 600. On the other side is a UI portion for host storage. Thus, files can be moved from host computer to pen device, and vice versa, and additional file system controls may be presented to search pen storage, delete pen storage, transmit a selected file to the host computer, receive files from the host computer, search host storage, browse an object in host storage, etc.

Any typical file system operation may thus be presented to move data to and from the pen storage device, which may appear to the user of the host machine as a separate drive, much like a camera when connected to a host computer or a USB flash storage device when connected to a host computer. In this fashion, data, such as music files, may be easily uploaded to the pen device and transferred from the pen device to the host device in accordance with the various embodiments of a dual mode pen in accordance with the invention. In an exemplary non-limiting embodiment of the invention, the invention leverages the file system of the host computer so that the “look and feel” of the host computer's file system is presented to the user, e.g., the pen storage device appears as its own drive or folder, optionally appearing as a pen storage device icon, and the user can drag and drop files, and otherwise copy, move or delete files according to standard operation and interface techniques of the host computer's file system. It should be noted and can be appreciated by one of ordinary skill in the art that a host computer as referred to herein is meant to be general, and includes, but is not limited to an embodiment wherein the host computer is another pen device, such that a wired or wireless transfer of data (e.g., business cards, public domain media content, word processing documents, etc.) takes place between two pen devices.

Exemplary Networked and Distributed Environments

One of ordinary skill in the art can appreciate that the invention can be implemented in connection with input device of any computer or other client or server device, which can be deployed as part of a computer network, or in a distributed computing environment. In this regard, the present invention thus extends to any computer system or environment having any number of memory or storage units, and any number of applications and processes occurring across any number of storage units or volumes, which may be used in connection with processes for providing a dual mode input device in accordance with the present invention. The present invention may apply to an environment with server computers and client computers deployed in a network environment or distributed computing environment, having remote or local storage. The present invention may also be applied in the context of standalone computing devices, having programming language functionality, interpretation and execution capabilities for generating, receiving and transmitting information in connection with remote or local services and processes. Data can originate from anywhere in a computer network, and thus the techniques for providing alternate modes for an input device in accordance with the present invention can be applied with great efficacy in those environments.

Distributed computing provides sharing of computer resources and services by exchange between computing devices and systems. These resources and services include the exchange of information, cache storage and disk storage for objects, such as files. Distributed computing takes advantage of network connectivity, allowing clients to leverage their collective power to benefit the entire enterprise. In this regard, a variety of devices may have applications, objects or resources that may implicate the systems and methods for providing and using a dual mode input device in accordance with the invention.

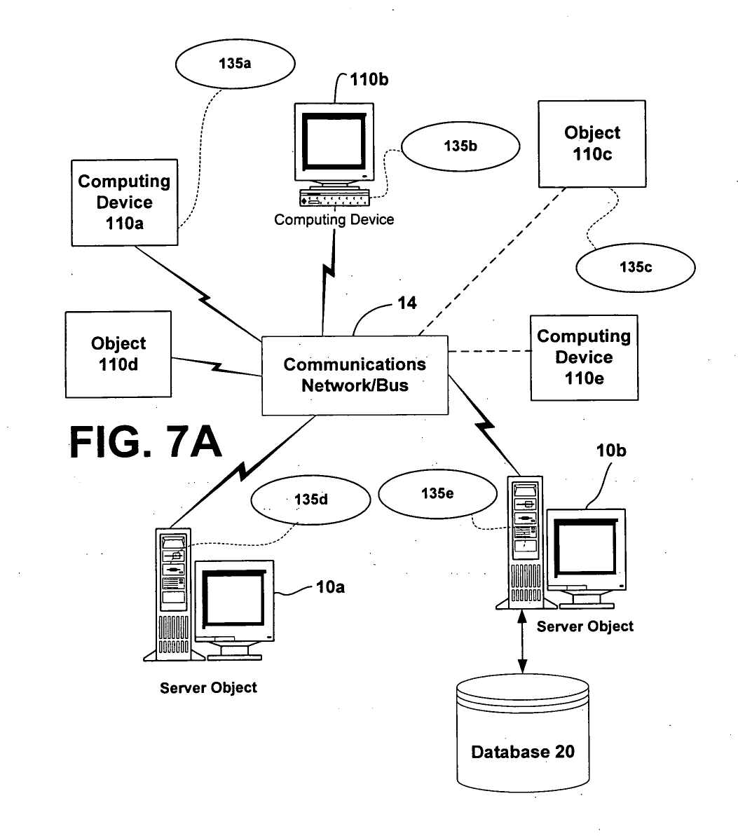

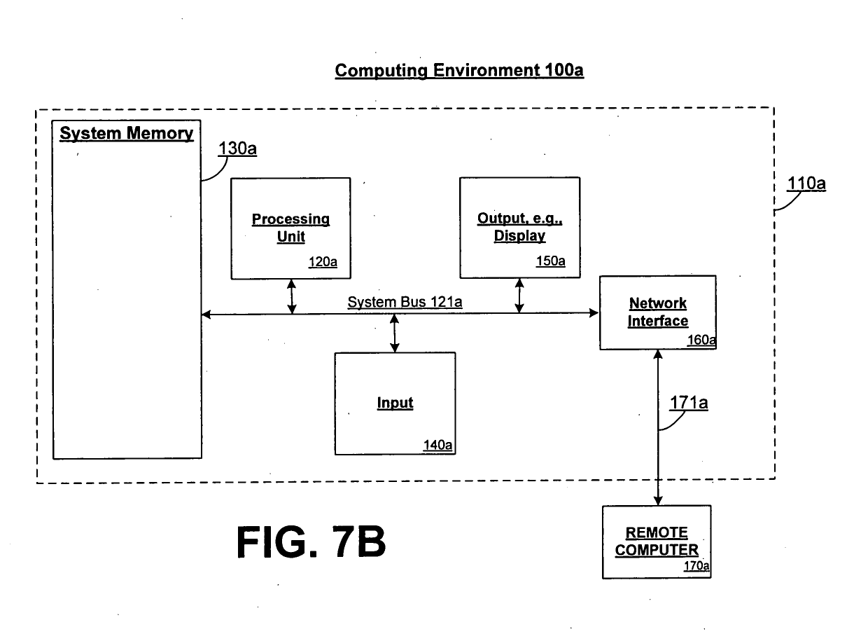

FIG. 7A provides a schematic diagram of an exemplary networked or distributed computing environment. The distributed computing environment comprises computing objects 10a, 10b, etc. and computing objects or devices 110a, 110b, 110c, etc. These objects may comprise programs, methods, data stores, programmable logic, etc. The objects may comprise portions of the same or different devices such as PDAs, audio/video devices, MP3 players, personal computers, etc. Each object can communicate with another object by way of the communications network 14. This network may itself comprise other computing objects and computing devices that provide services to the system of FIG. 7A, and may itself represent multiple interconnected networks. In accordance with an aspect of the invention, each object 10a, 10b, etc. or 110a, 110b, 110c, etc. may contain an application that might make use of an API, or other object, software, firmware and/or hardware, suitable for use with the systems and methods for providing a dual mode input device in accordance with the invention.

It can also be appreciated that an object, such as 110c, may be hosted on another computing device 10a, 10b, etc. or 110a, 110b, etc. Thus, although the physical environment depicted may show the connected devices as computers, such illustration is merely exemplary and the physical environment may alternatively be depicted or described comprising various digital devices such as PDAs, televisions, MP3 players, etc., software objects such as interfaces, COM objects and the like.

There are a variety of systems, components, and network configurations that support distributed computing environments. For example, computing systems may be connected together by wired or wireless systems, by local networks or widely distributed networks. Currently, many of the networks are coupled to the Internet, which provides an infrastructure for widely distributed computing and encompasses many different networks. Any of the infrastructures may be used for exemplary communications made incident to a dual mode input device according to the present invention.

In home networking environments, there are at least four disparate network transport media that may each support a unique protocol, such as Power line, data (both wireless and wired), voice (e.g., telephone) and entertainment media. Most home control devices such as light switches and appliances may use power lines for connectivity. Data Services may enter the home as broadband (e.g., either DSL or Cable modem) and are accessible within the home using either wireless (e.g., HomeRF or 802.11B) or wired (e.g., Home PNA, Cat 5, Ethernet, even power line) connectivity. Voice traffic may enter the home either as wired (e.g., Cat 3) or wireless (e.g., cell phones) and may be distributed within the home using Cat 3 wiring. Entertainment media, or other graphical data, may enter the home either through satellite or cable and is typically distributed in the home using coaxial cable. IEEE 1394 and DVI are also digital interconnects for clusters of media devices. All of these network environments and others that may emerge, or already have emerged, as protocol standards may be interconnected to form a network, such as an intranet, that may be connected to the outside world by way of a wide area network, such as the Internet. In short, a variety of disparate sources exist for the storage and transmission of data, and consequently, moving forward, computing devices will require ways of sharing data, such as data accessed or utilized incident to program objects, which communicate with a dual mode input device in accordance with the present invention.

The Internet commonly refers to the collection of networks and gateways that utilize the Transmission Control Protocol/Internet Protocol (TCP/IP) suite of protocols, which are well-known in the art of computer networking. The Internet can be described as a system of geographically distributed remote computer networks interconnected by computers executing networking protocols that allow users to interact and share information over network(s). Because of such wide-spread information sharing, remote networks such as the Internet have thus far generally evolved into an open system with which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the illustration of FIG. 7A, as an example, computers 110a, 110b, etc. can be thought of as clients and computers 10a, 10b, etc. can be thought of as servers where servers 10a, 10b, etc. maintain the data that is then replicated to client computers 110a, 110b, etc., although any computer can be considered a client, a server, or both, depending on the circumstances. Any of these computing devices may be processing data or requesting services or tasks that may implicate interfacing with the dual mode input device in accordance with the invention.

A server is typically a remote computer system accessible over a remote or local network, such as the Internet. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques for communicating with a dual mode input device of the invention may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

Thus, FIG. 7A illustrates an exemplary networked or distributed environment, with server(s) in communication with client computer (s) via a network/bus, in which the present invention may be employed. In more detail, a number of servers 10a, 10b, etc., are interconnected via a communications network/bus 14, which may be a LAN, WAN, intranet, the Internet, etc., with a number of client or remote computing devices 110a, 110b, 110c, 110d, 110e, etc., such as a portable computer, handheld computer, thin client, networked appliance, or other device, such as a VCR, TV, oven, light, heater and the like in accordance with the present invention. It is thus contemplated that the present invention may apply to any computing device in connection with which it is desirable to use either mode of the dual mode input device of the invention.

In a network environment in which the communications network/bus 14 is the Internet, for example, the servers 10a, 10b, etc. can be Web servers with which the clients 110a, 110b, 110c, 110d, 110e, etc. communicate via any of a number of known protocols such as HTTP. Servers 10a, 10b, etc. may also serve as clients 110a, 110b, 110c, 110d, 110e, etc., as may be characteristic of a distributed computing environment.

As mentioned, communications may be wired or wireless, or a combination, where appropriate. Client devices 110a, 110b, 110c, 110d, 110e, etc. may or may not communicate via communications network/bus 14, and may have independent communications associated therewith. For example, in the case of a TV or VCR, there may or may not be a networked aspect to the control thereof. Each client computer 110a, 110b, 110c, 110d, 110e, etc. and server computer 10a, 10b, etc. may be equipped with various application program modules or objects 135a, 135b, 135c, etc. and with connections or access to various types of storage elements or objects, across which files or data streams may be stored or to which portion(s) of files or data streams may be downloaded, transmitted or migrated. Any one or more of computers 10a, 10b, 110a, 110b, etc. may be responsible for the maintenance and updating of a database 20 or other storage element, such as a database or memory 20 for storing data processed or saved according to the invention. Thus, the present invention can be utilized in a computer network environment having client computers 110a, 110b, etc. that can access and interact with a computer network/bus 14 and server computers 10a, 10b, etc. that may interact with client computers 110a, 110b, etc. and other like devices, and databases 20.

Exemplary Computing Device

FIG. 7B and the following discussion are intended to provide a brief general description of a suitable computing environment in connection with which the invention may be utilized. It should be understood, however, that handheld, portable and other computing devices and computing objects of all kinds are contemplated for use in connection with the present invention, i.e., anywhere where that it is desirable to flexibly, or quickly access data or provide input in a computing environment. While a general purpose computer is described below, this is but one example, and the present invention may be implemented with a thin client having network/bus interoperability and interaction. Thus, the present invention may be implemented in an environment of networked hosted services in which very little or minimal client resources are implicated, e.g., a networked environment in which the client device serves merely as an interface to the network/bus, such as an object placed in an appliance. In essence, anywhere that data may be stored or from which data may be retrieved or transmitted to another computer is a desirable, or suitable, environment for operation of the techniques for providing a dual mode input device in accordance with the invention.

Although not required, the invention can be implemented via an operating system, for use by a developer of services for a device or object, and/or included within application software that operates in connection with the methods for communicating with a dual mode input device of the invention. Software may be described in the general context of computer-executable instructions, such as program modules, being executed by one or more computers, such as client workstations, servers or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations and protocols. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, appliances, lights, environmental control elements, minicomputers, mainframe computers and the like. The invention may also be practiced in distributed computing environments where tasks are performed by remote processing devices that are linked through a communications network/bus or other data transmission medium. In a distributed computing environment, program modules may be located in both local and remote computer storage media including memory storage devices, and client nodes may in turn behave as server nodes, as described above.

Exemplary Computing Device

As mentioned, the invention applies to any device wherein it may be desirable to shield a primary application from interference from secondary applications of the device. It should be understood, therefore, that handheld, portable and other computing devices and computing objects of all kinds are contemplated for use in connection with the present invention, i.e., anywhere that a device may receive content according to a variety of channels. Accordingly, the below general purpose remote computer described below in FIG. 7B is but one example, and the present invention may be implemented with any client having network/bus interoperability and interaction. Thus, the present invention may be implemented in an environment of networked hosted services in which very little or minimal client resources are implicated, e.g., a networked environment in which the client device serves merely as an interface to the network/bus, such as an object placed in an appliance.

Although not required, the invention can partly be implemented via an operating system, for use by a developer of services for a device or object, and/or included within application software that operates in connection with the component(s) of the invention. Software may be described in the general context of computer-executable instructions, such as program modules, being executed by one or more computers, such as client workstations, servers or other devices. Those skilled in the art will appreciate that the invention may be practiced with other computer system configurations and protocols.

FIG. 7B thus illustrates an example of a suitable computing system environment 100a in which the invention may be implemented, although as made clear above, the computing system environment 100a is only one example of a suitable computing environment for a media device and is not intended to suggest any limitation as to the scope of use or functionality of the invention. Neither should the computing environment 100a be interpreted as having any dependency or requirement relating to any one or combination of components illustrated in the exemplary operating environment 100a.

With reference to FIG. 7B, an exemplary remote device for implementing the invention includes a general purpose computing device in the form of a computer 110a. Components of computer 110a may include, but are not limited to, a processing unit 120a, a system memory 130a, and a system bus 121a that couples various system components including the system memory to the processing unit 120a. The system bus 121a may be any of several types of bus structures including a memory bus or memory controller, a peripheral bus, and a local bus using any of a variety of bus architectures.

Computer 110a typically includes a variety of computer readable media. Computer readable media can be any available media that can be accessed by computer 110a. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110a. Communication media typically embodies computer readable instructions, data structures, program modules or other data in a modulated data signal such as a carrier wave or other transport mechanism and includes any information delivery media.

The system memory 130a may include computer storage media in the form of volatile and/or nonvolatile memory such as read only memory (ROM) and/or random access memory (RAM). A basic input/output system (BIOS), containing the basic routines that help to transfer information between elements within computer 110a, such as during start-up, may be stored in memory 130a. Memory 130a typically also contains data and/or program modules that are immediately accessible to and/or presently being operated on by processing unit 120a. By way of example, and not limitation, memory 130a may also include an operating system, application programs, other program modules, and program data.

The computer 110a may also include other removable/non-removable, volatile/nonvolatile computer storage media. For example, computer 110a could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 121a through a non-removable memory interface such as an interface, and a magnetic disk drive or optical disk drive is typically connected to the system bus 121a by a removable memory interface, such as an interface.

A user may enter commands and information into the computer 110a through input devices such as a keyboard and pointing device, commonly referred to as a mouse, trackball or touch pad. Other input devices may include a microphone, joystick, game pad, satellite dish, scanner, or the like. These and other input devices are often connected to the processing unit 120a through user input 140a and associated interface(s) that are coupled to the system bus 121a, but may be connected by other interface and bus structures, such as a parallel port, game port or a universal serial bus (USB). A graphics subsystem may also be connected to the system bus 121a. A monitor or other type of display device is also connected to the system bus 121a via an interface, such as output interface 150a, which may in turn communicate with video memory. In addition to a monitor, computers may also include other peripheral output devices such as speakers and a printer, which may be connected through output interface 150a.

The computer 110a may operate in a networked or distributed environment using logical connections to one or more other remote computers, such as remote computer 170a, which may in turn have media capabilities different from device 110a. The remote computer 170a may be a personal computer, a server, a router, a network PC, a peer device or other common network node, or any other remote media consumption or transmission device, and may include any or all of the elements described above relative to the computer 110a. The logical connections depicted in FIG. 7B include a network 171a, such local area network (LAN) or a wide area network (WAN), but may also include other networks/buses. Such networking environments are commonplace in homes, offices, enterprise-wide computer networks, intranets and the Internet.

When used in a LAN networking environment, the computer 110a is connected to the LAN 171a through a network interface or adapter. When used in a WAN networking environment, the computer 110a typically includes a modem or other means for establishing communications over the WAN, such as the Internet. A modem, which may be internal or external, may be connected to the system bus 121a via the user input interface of input 140a, or other appropriate mechanism. In a networked environment, program modules depicted relative to the computer 110a, or portions thereof, may be stored in a remote memory storage device. It will be appreciated that the network connections shown and described are exemplary and other means of establishing a communications link between the computers may be used.

Exemplary Distributed Computing Frameworks or Architectures

Various distributed computing frameworks have been and are being developed in light of the convergence of personal computing and the Internet. Individuals and business users alike are provided with a seamlessly interoperable and Web-enabled interface for applications and computing devices, making computing activities increasingly Web browser or network-oriented.

For example, MICROSOFT®'s managed code platform, i.e., .NET, includes servers, building-block services, such as Web-based data storage and downloadable device software. Generally speaking, the .NET platform provides (1) the ability to make the entire range of computing devices work together and to have user information automatically updated and synchronized on all of them, (2) increased interactive capability for Web pages, enabled by greater use of XML rather than HTML, (3) online services that feature customized access and delivery of products and services to the user from a central starting point for the management of various applications, such as e-mail, for example, or software, such as Office .NET, (4) centralized data storage, which increases efficiency and ease of access to information, as well as synchronization of information among users and devices, (5) the ability to integrate various communications media, such as e-mail, faxes, and telephones, (6) for developers, the ability to create reusable modules, thereby increasing productivity and reducing the number of programming errors and (7) many other cross-platform and language integration features as well.

While some exemplary embodiments herein are described in connection with software, such as an application programming interface (API), residing on a computing device, one or more portions of the invention may also be implemented via an operating system, or a “middle man” object, a control object, hardware, firmware, intermediate language instructions or objects, etc., such that the methods for communicating with a dual mode input device in accordance with the invention may be included in, supported in or accessed via all of the languages and services enabled by managed code, such as .NET code, and in other distributed computing frameworks as well.

Exemplary Interface Implementations

For any exchange of data among multiple computers, such as sharing, accessing, rendering, downloading or uploading data to or from a dual mode input device of the invention and a computing device according to the techniques of the invention and shared between two computers, there are interfaces for handling the various operations on the dual mode input device and/or the computing device that can be implemented in hardware and/or software and which operate to receive, send and/or process the data in some fashion, according to the relevant applications and services being requested or provided. To the extent that one or more interface objects may be provided to achieve or implement any portion of the systems and methods for providing, using or communicating with a dual mode input device in accordance with the invention, the invention is intended to encompass all such embodiments, and thus a general description of the kinds of interfaces that might be provided or utilized when implementing or carrying out the invention follows.

A programming interface (or more simply, interface) may be viewed as any mechanism, process, protocol for enabling one or more segment(s) of code to communicate with or access the functionality provided by one or more other segment(s) of code. Alternatively, a programming interface may be viewed as one or more mechanism(s), method(s), function call(s), module(s), object(s), etc. of a component of a system capable of communicative coupling to one or more mechanism(s), method(s), function call(s), module(s), etc. of other component(s). The term “segment of code” in the preceding sentence is intended to include one or more instructions or lines of code, and includes, e.g., code modules, objects, subroutines, functions, and so on, regardless of the terminology applied or whether the code segments are separately compiled, or whether the code segments are provided as source, intermediate, or object code, whether the code segments are utilized in a runtime system or process, or whether they are located on the same or different machines or distributed across multiple machines, or whether the functionality represented by the segments of code are implemented wholly in software, wholly in hardware, or a combination of hardware and software.

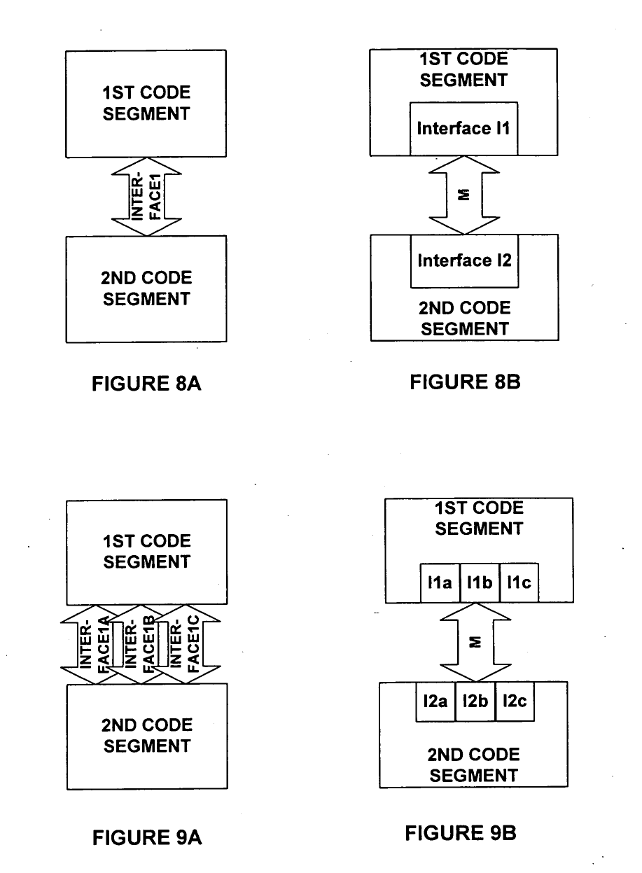

Notionally, a programming interface may be viewed generically, as shown in FIG. 8A or FIG. 8B. FIG. 8A illustrates an interface Interface1 as a conduit through which first and second code segments communicate. FIG. 8B illustrates an interface as comprising interface objects I1 and I2 (which may or may not be part of the first and second code segments), which enable first and second code segments of a system to communicate via medium M. In the view of FIG. 8B, one may consider interface objects I1 and I2 as separate interfaces of the same system and one may also consider that objects I1 and I2 plus medium M comprise the interface. Although FIGS. 8A and 8B show bi-directional flow and interfaces on each side of the flow, certain implementations may only have information flow in one direction (or no information flow as described below) or may only have an interface object on one side. By way of example, and not limitation, terms such as application programming interface (API), entry point, method, function, subroutine, remote procedure call, and component object model (COM) interface, are encompassed within the definition of programming interface.

Aspects of such a programming interface may include the method whereby the first code segment transmits information (where “information” is used in its broadest sense and includes data, commands, requests, etc.) to the second code segment; the method whereby the second code segment receives the information; and the structure, sequence, syntax, organization, schema, timing and content of the information. In this regard, the underlying transport medium itself may be unimportant to the operation of the interface, whether the medium be wired or wireless, or a combination of both, as long as the information is transported in the manner defined by the interface. In certain situations, information may not be passed in one or both directions in the conventional sense, as the information transfer may be either via another mechanism (e.g. information placed in a buffer, file, etc. separate from information flow between the code segments) or non-existent, as when one code segment simply accesses functionality performed by a second code segment. Any or all of these aspects may be important in a given situation, e.g., depending on whether the code segments are part of a system in a loosely coupled or tightly coupled configuration, and so this list should be considered illustrative and non-limiting.

This notion of a programming interface is known to those skilled in the art and is clear from the foregoing detailed description of the invention. There are, however, other ways to implement a programming interface, and, unless expressly excluded, these too are intended to be encompassed by the claims set forth at the end of this specification. Such other ways may appear to be more sophisticated or complex than the simplistic view of FIGS. 8A and 8B, but they nonetheless perform a similar function to accomplish the same overall result. We will now briefly describe some illustrative alternative implementations of a programming interface.

A. Factoring

A communication from one code segment to another may be accomplished indirectly by breaking the communication into multiple discrete communications. This is depicted schematically in FIGS. 9A and 9B. As shown, some interfaces can be described in terms of divisible sets of functionality. Thus, the interface functionality of FIGS. 8A and 8B may be factored to achieve the same result, just as one may mathematically provide 24, or 2 times 2 time 3 times 2. Accordingly, as illustrated in FIG. 9A, the function provided by interface Interface1 may be subdivided to convert the communications of the interface into multiple interfaces Interface 1A, Interface 1B, Interface 1C, etc. while achieving the same result. As illustrated in FIG. 9B, the function provided by interface I1 may be subdivided into multiple interfaces I1a, I1b, I1c, etc. while achieving the same result. Similarly, interface I2 of the second code segment which receives information from the first code segment may be factored into multiple interfaces I2a, I2b, I2c, etc. When factoring, the number of interfaces included with the 1^{st} code segment need not match the number of interfaces included with the 2^{nd} code segment. In either of the cases of FIGS. 9A and 9B, the functional spirit of interfaces Interface1 and I1 remain the same as with FIGS. 8A and 8B, respectively. The factoring of interfaces may also follow associative, commutative, and other mathematical properties such that the factoring may be difficult to recognize. For instance, ordering of operations may be unimportant, and consequently, a function carried out by an interface may be carried out well in advance of reaching the interface, by another piece of code or interface, or performed by a separate component of the system. Moreover, one of ordinary skill in the programming arts can appreciate that there are a variety of ways of making different function calls that achieve the same result.

B. Redefinition

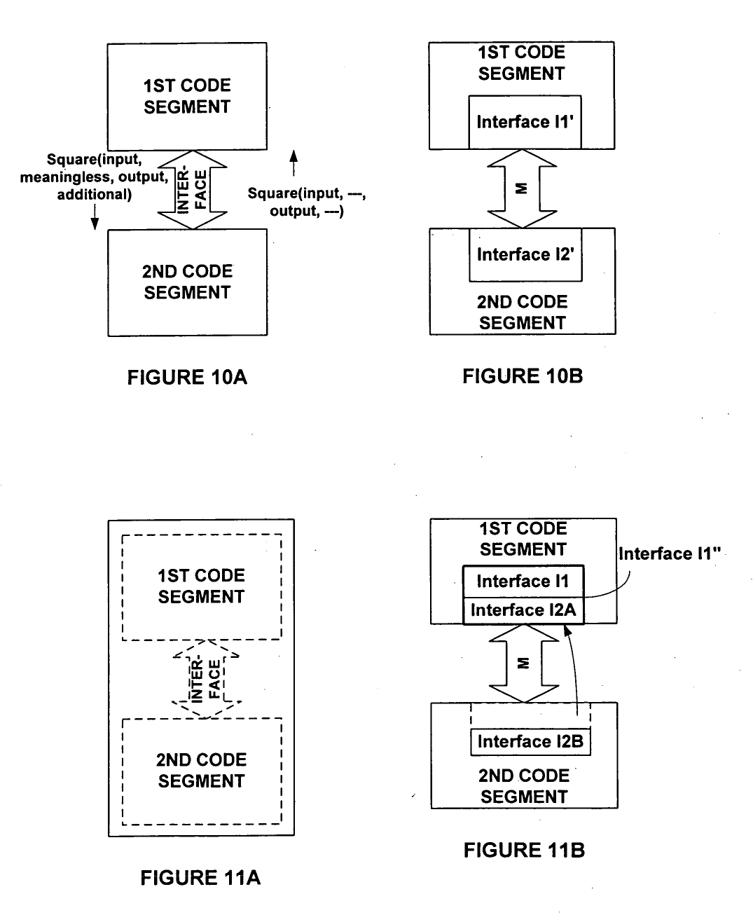

In some cases, it may be possible to ignore, add or redefine certain aspects (e.g., parameters) of a programming interface while still accomplishing the intended result. This is illustrated in FIGS. 10A and 10B. For example, assume interface Interface1 of FIG. 8A includes a function call Square (input, precision, output), a call that includes three parameters, input, precision and output, and which is issued from the 1^{st} Code Segment to the 2^{nd} Code Segment., If the middle parameter precision is of no concern in a given scenario, as shown in FIG. 10A, it could just as well be ignored or even replaced with a meaningless (in this situation) parameter. One may also add an additional parameter of no concern. In either event, the functionality of square can be achieved, so long as output is returned after input is squared by the second code segment. Precision may very well be a meaningful parameter to some downstream or other portion of the computing system; however, once it is recognized that precision is not necessary for the narrow purpose of calculating the square, it may be replaced or ignored. For example, instead of passing a valid precision value, a meaningless value such as a birth date could be passed without adversely affecting the result. Similarly, as shown in FIG. 10B, interface I1 is replaced by interface I1′, redefined to ignore or add parameters to the interface. Interface I2 may similarly be redefined as interface I2′, redefined to ignore unnecessary parameters, or parameters that may be processed elsewhere. The point here is that in some cases a programming interface may include aspects, such as parameters, which are not needed for some purpose, and so they may be ignored or redefined, or processed elsewhere for other purposes.

C. Inline Coding

It may also be feasible to merge some or all of the functionality of two separate code modules such that the “interface” between them changes form. For example, the functionality of FIGS. 8A and 8B may be converted to the functionality of FIGS. 11A and 11B, respectively. In FIG. 11A, the previous 1^{st} and 2^{nd} Code Segments of FIG. 8A are merged into a module containing both of them. In this case, the code segments may still be communicating with each other but the interface may be adapted to a form which is more suitable to the single module. Thus, for example, formal Call and Return statements may no longer be necessary, but similar processing or response(s) pursuant to interface Interface1 may still be in effect. Similarly, shown in FIG. 11B, part (or all) of interface I2 from FIG. 8B may be written inline into interface I1 to form interface I1″. As illustrated, interface I2 is divided into 12a and 12b, and interface portion 12a has been coded in-line with interface I1 to form interface I1″. For a concrete example, consider that the interface I1 from FIG. 8B performs a function call square (input, output), which is received by interface I2, which after processing the value passed with input (to square it) by the second code segment, passes back the squared result with output. In such a case, the processing performed by the second code segment (squaring input) can be performed by the first code segment without a call to the interface.

D. Divorce

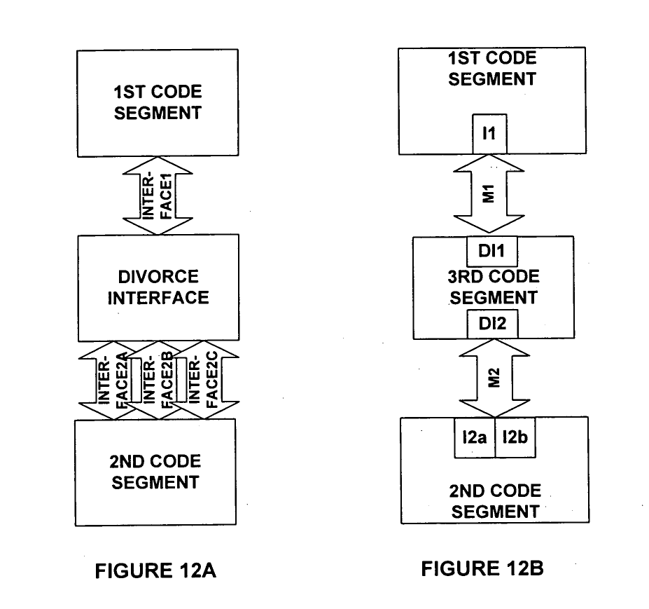

A communication from one code segment to another may be accomplished indirectly by breaking the communication into multiple discrete communications. This is depicted schematically in FIGS. 12A and 12B. As shown in FIG. 12A, one or more piece(s) of middleware (Divorce Interface(s), since they divorce functionality and/or interface functions from the original interface) are provided to convert the communications on the first interface, Interface1, to conform them to a different interface, in this case interfaces Interface2A, Interface2B and Interface2C. This might be done, e.g., where there is an installed base of applications designed to communicate with, say, an operating system in accordance with an Interface1 protocol, but then the operating system is changed to use a different interface, in this case interfaces Interface2A, Interface2B and Interface2C. The point is that the original interface used by the 2^{nd} Code Segment is changed such that it is no longer compatible with the interface used by the 1^{st} Code Segment, and so an intermediary is used to make the old and new interfaces compatible. Similarly, as shown in FIG. 12B, a third code segment can be introduced with divorce interface DI1 to receive the communications from interface I1 and with divorce interface DI2 to transmit the interface functionality to, for example, interfaces I2a and I2b, redesigned to work with DI2, but to provide the same functional result. Similarly, DI1 and DI2 may work together to translate the functionality of interfaces I1 and I2 of FIG. 8B to a new operating system, while providing the same or similar functional result.

E. Rewriting

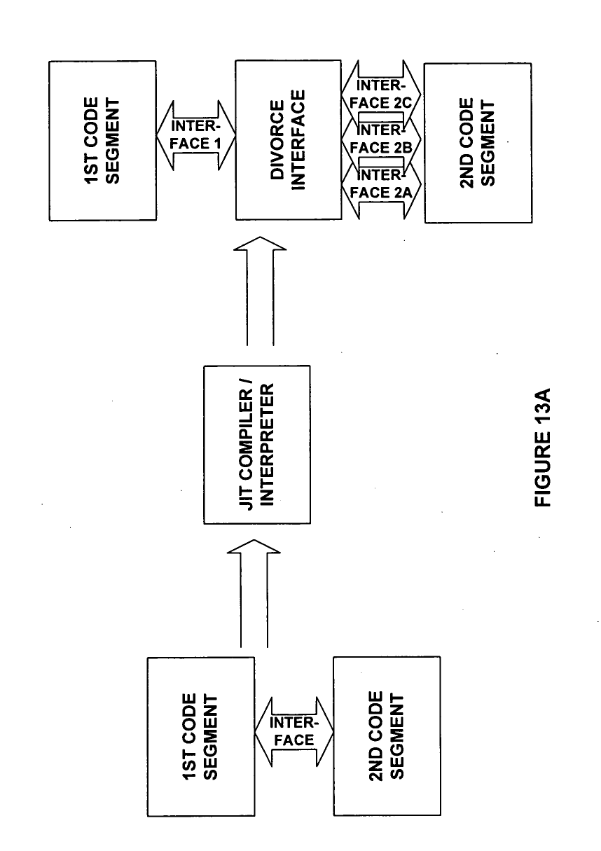

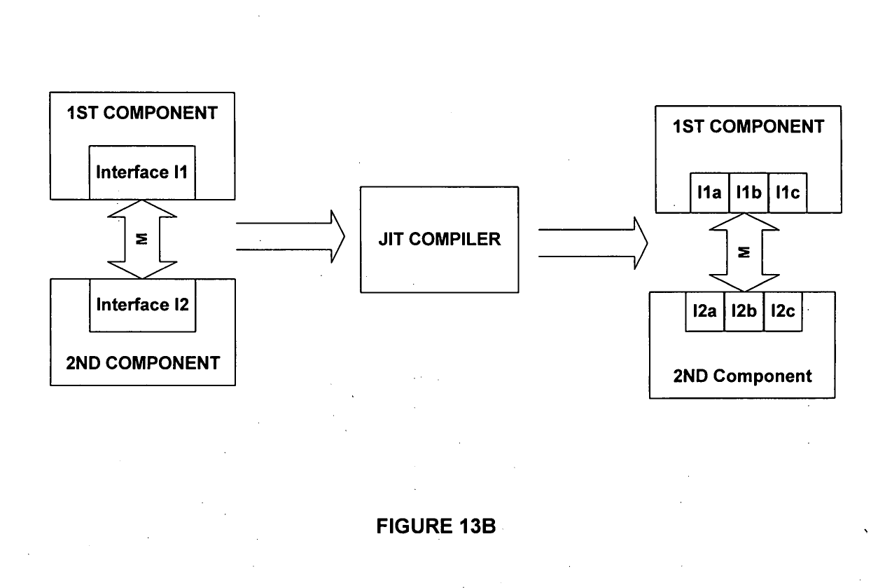

Yet another possible variant is to dynamically rewrite the code to replace the interface functionality with something else but which achieves the same overall result. For example, there may be a system in which a code segment presented in an intermediate language (e.g. Microsoft IL, Java ByteCode, etc.) is provided to a Just-in-Time (JIT) compiler or interpreter in an execution environment (such as that provided by the Net framework, the Java runtime environment, or other similar runtime type environments). The JIT compiler may be written so as to dynamically convert the communications from the 1^{st} Code Segment to the 2^{nd} Code Segment, i.e., to conform them to a different interface as may be required by the 2^{nd} Code Segment (either the original or a different 2^{nd} Code Segment). This is depicted in FIGS. 13A and 13B. As can be seen in FIG. 13A, this approach is similar to the Divorce scenario described above. It might be done, e.g., where an installed base of applications are designed to communicate with an operating system in accordance with an Interface 1 protocol, but then the operating system is changed to use a different interface. The JIT Compiler could be used to conform the communications on the fly from the installed-base applications to the new interface of the operating system. As depicted in FIG. 13B, this approach of dynamically rewriting the interface(s) may be applied to dynamically factor, or otherwise alter the interface(s) as well.

It is also noted that the above-described scenarios for achieving the same or similar result as an interface via alternative embodiments may also be combined in various ways, serially and/or in parallel, or with other intervening code. Thus, the alternative embodiments presented above are not mutually exclusive and may be mixed, matched and combined to produce the same or equivalent scenarios to the generic scenarios presented in FIGS. 8A and 8B. It is also noted that, as with most programming constructs, there are other similar ways of achieving the same or similar functionality of an interface which may not be described herein, but nonetheless are represented by the spirit and scope of the invention, i.e., it is noted that it is at least partly the functionality represented by, and the advantageous results enabled by, an interface that underlie the value of an interface.

There are multiple ways of implementing the present invention, e.g., an appropriate API, tool kit, driver code, operating system, control, standalone or downloadable software object, etc. which enables applications and services to use the systems and methods for downloading algorithmic elements to a coprocessor of the invention. The invention contemplates the use of the invention from the standpoint of an API (or other software object), as well as from a software or hardware object that receives a downloaded program in accordance with the invention. Thus, various implementations of the invention described herein may have aspects that are wholly in hardware, partly in hardware and partly in software, as well as in software.

As mentioned above, while exemplary embodiments of the present invention have been described in connection with various computing devices and network architectures, the underlying concepts may be applied to any computing device or system in which it is desirable to share data with a pen storage device. For instance, the algorithm(s) and hardware implementations of the invention may be applied to the operating system of a computing device, provided as a separate object on the device, as part of another object, as a reusable control, as a downloadable object from a server, as a “middle man” between a device or object and the network, as a distributed object, as hardware, in memory, a combination of any of the foregoing, etc. While exemplary programming languages, names and examples are chosen herein as representative of various choices, these languages, names and examples are not intended to be limiting. One of ordinary skill in the art will appreciate that there are numerous ways of providing object code and nomenclature that achieves the same, similar or equivalent functionality achieved by the various embodiments of the invention.

As mentioned, the various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the functionality of the storage pen of the present invention, e.g., through the use of a data processing API, controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, etc., the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate.

While exemplary embodiments refer to utilizing the present invention in the context of particular programming language constructs, the invention is not so limited, but rather may be implemented in any language to provide methods for exchanging, reading and/or writing data in storage memory of a pen in accordance with the invention. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed:

1. A method for utilizing an electronic pointing device having a memory, comprising:
selecting one of a first mode of operation for the electronic pointing device and a second mode of operation for the electronic pointing device;
whereby when the first mode is selected, the electronic pointing device operates to store positional information in memory of the electronic pointing device about movement of the electronic pointing device for the purpose of transmitting the positional information to a host device as input to the host device; and
whereby when the second mode is selected, the electronic pointing device operates to allow user access to at least one data file in said memory for the purpose of performing some operation on said at least one data file.

2. A method according to claim 1, further comprising:
connecting to the host device via at least one interface of the electronic pointing device and transmitting said at least one data file from the electronic pointing device to the host device via said at least one interface.

3. A method according to claim 1, further comprising:
connecting to the host device via at least one interface of the electronic pointing device and receiving at least one further data file from host device and storing the at least one further data file in said memory.

4. A method according to claim 1, further comprising:
connecting to the host device via at least one interface of the electronic pointing device;
receiving a request to delete a data file of said at least one data file; and
deleting said at least one data file from the electronic pointing device in response to said request.

5. A method according to claim 1, wherein the at least one data file is at least one of password protected, encrypted and overwrite protected.

6. A method according to claim 1, wherein the memory is flash memory, said at least one interface includes at least one of a universal serial bus (USB) interface, an 802.11x interface and a Bluetooth interface.

7. A method according to claim 1, further comprising:
when in the second mode wherein the at least one data file in memory includes at least one music file, receiving a request to play a music file; and
generating and outputting an audio signal from the pen device based on the music file in response to the request.

8. A method according to claim 1, further comprising:
when in the second mode wherein the electronic pen device includes a camera mechanism, receiving a request to capture at least one image with the camera mechanism; and
capturing and storing the at least one image in said memory.

9. An application programming interface comprising computer executable interface modules having computer executable instructions for performing the method of claim 1.

10. An electronic pen device including means for performing the method of claim 1.

11. A user interface of a computing device for displaying information relating to a dual mode electronic pen device including a first mode for storing positional information in memory of the electronic pointing device relating to the movement of the electronic pointing device and a second mode that allows user access to at least one data file in said memory for the purpose of performing some operation on said at least one data file, including:
a user interface component for displaying metadata relating to the at least one data file stored in said memory, whereby said user interface component is instantiated when the electronic pen device is connected to the computing device via at least one interface.

12. A user interface according to claim 11, further comprising:
wherein said user interface component includes a control enabling a user to receive any one of said at least one data file from the electronic pen device via said at least one interface and store the received at least one data file on the computing device.

13. A user interface according to claim 11, further comprising:
wherein said user interface component includes a control enabling a user to transmit a host data file from the computing device to the electronic pen device via said at least one interface for storage in said memory of the electronic pen device.

14. A user interface according to claim 11, further comprising:
wherein said user interface component includes a control enabling a user to delete at least one of said at least one data file from the electronic pointing device.

15. A user interface according to claim 11, wherein the user interface component includes a security component for decrypting said at least one data file stored in the electronic pen device.

16. A dual mode electronic stylus device, comprising:
a memory that stores positional data about the electronic stylus device and at least one data file not relating to any positional data about the electronic stylus device;
first electronics corresponding to a first mode of operation for the electronic stylus device, whereby when the electronic stylus device operates in the first mode, the electronic stylus device operates to store positional information concerning movement of the electronic stylus device in said memory of the electronic stylus device;
second electronics corresponding to a second mode of operation for the electronic stylus device, whereby when the electronic stylus device operates in the second mode, the electronic stylus device operates to allow user access to at least one data file stored said memory; and
an actuatable switch component for switching between the first and second modes of operation.

17. A dual mode electronic stylus device according to claim 16, further comprising:
at least one interface for connecting the electronic stylus device to a host device enabling the transmission of said at least one data file from the electronic stylus device to the host device.

18. A dual mode electronic stylus device according to claim 16, further comprising:
at least one interface for connecting the electronic stylus device to a host device enabling the reception of at least one host data file by the electronic stylus device from the host device.

19. A dual mode electronic stylus device according to claim 16, further comprising:
means for protecting said at least one data file from unrestricted access while stored in said memory of said dual mode electronic stylus device.

20. A dual mode electronic stylus device according to claim 16, further comprising:
at least one of a music player for playing a music file of said at least one data file while in the second mode of operation and a camera mechanism for capturing at least one image and storing said at least one image to said memory.
